(19) United States
(12) Patent Application Publication
(10) Pub. No.: US 2024/0389173 A1
(43) Pub. Date: Nov. 21, 2024

(54) METHOD AND MICROPROCESSOR FOR ENABLING DEVICE TO CONNECT WITH PLURAL HOST DEVICES

(71) Applicant: Acrox Technologies Co., Ltd., Taipei (TW)

(72) Inventor: Chin-Sung HO, Taipei (TW)

(21) Appl. No.: 18/664,298

(22) Filed: May 15, 2024

(30) Foreign Application Priority Data
May 19, 2023 (TW) 112118813

(51) Int. Cl. H04W 76/14; H04W 76/15; H04W 76/19

(52) U.S. Cl. CPC H04W 76/14; H04W 76/15; H04W 76/19

(57) ABSTRACT

A microprocessor for enabling a device to connect with plural hosts including a first host and a second host is disclosed. The microprocessor includes a first determination module configured to enable the device to determine if the first host is to be operable by the device; and a second determination module configured to, when the device has not been successfully connected with the first host, determine if the device has ever been paired with the second host: if yes, enabling the device to pair with the second host, and causing the second host to be operable by the device; and if no, enabling the device to reconnect with the second host, and causing the second host to be operable by the device.

### CROSS-REFERENCE TO RELATED APPLICATION AND CLAIM OF PRIORITY

This application claims the benefit of the Taiwan Patent Application No. 112118813, filed on May 19, 2023 at the Taiwan Intellectual Property Office, the disclosures of which are incorporated herein in their entirety by reference.

### FIELD OF THE INVENTION

The present disclosure relates to a method and a microprocessor for enabling a device to connect with a host. More specifically, the present disclosure relates to a method and a microprocessor for enabling a device to connect with plural hosts.

### BACKGROUND OF THE INVENTION

A wireless human machine interface device (Hidentification code) is commonly a Bluetooth® device, such as a mouse, keyboard or joystick, serving as an input device for a host device such as a desktop computer and laptop computer. When a remote adapter (or a dongle) is matched to the device physically plugged in the host through a Universal Serial Bus (USB) port disposed thereon, a user can operate the host via the device. Alternatively, if the remote adapter is not physically plugged into the host, or the device is not equipped with a remote adapter, the device can still be paired one-to-one with the host through a Bluetooth connection by pressing the pairing button provided on the device. After the pairing is successful, the user can operate the paired host by manipulating the device. However, each pairing requires the user to manually operate the pairing button. Moreover, the device will only repeatedly connect with the paired host until the pairing button is pressed again. In addition, once the pairing button is pressed, the previously paired host will not be connected again when the other nearby host has been paired.

In addition, in order not to limit the device to enable its connection with only a single host, a device that can connect with plural hosts has been developed. For example, the same device is able to connect with a paired laptop computer (host A) in the user's office, and is also able to connect with a desktop computer (host B) in a client's conference room for making a presentation. After that, when the user returns to his office, the paired laptop (Host A) can still be operated again by the device through reconnection. For example, by manually pressing a switching button on the device to switchably choose to reconnect the paired host A or host B, or choose to pair the unpaired hosts C, D, E, etc.

However, in the prior art, the only way to choose a specific one among the paired hosts A, B, and even C, D and E to be operated by the user is to manually press a button switch on the device. Therefore, the user needs to spend extra time to pair or reconnect the device with a desired host before making the presentation, for example. However, it is undesirable that the user has to manually press the button switch one or more times in the event that the device cannot be automatically paired or reconnected with the desired host, which may cause customers or listeners to wait impatiently and thus in a bad mood.

In view of the above, the present invention proposes a method and a microprocessor having a software module with an algorithm or a firmware for enabling the device to connect with plural hosts, so that the device can determine by itself and choose to pair with an unpaired host or to reconnect with a paired host. With this method and/or the microprocessor, the device can automatically search for the host that the user intends to connect with without the need to design a pairing button on the device. Therefore, it is not necessary for the user to manually operate the pairing button on the device when choosing the desired host, which improves the convenience of operation. In addition, each user can have a dedicated device without sharing the device with other users, so as to avoid the propagation of infectious diseases (such as Covid-19 or influenza) through contact to the device between users. Therefore, the above-mentioned technical issues are improved.

### SUMMARY OF THE INVENTION

In accordance with one aspect of the present disclosure, a method for enabling a device to connect with plural hosts comprising a first host and one of a preset host and a second host is disclosed. The method comprises the following steps: (1) on a condition that the plural hosts comprise the preset host and the first host, the method comprising the following steps: enabling the device to enter into a preset mode, comprising the following steps: enabling the device to wirelessly connect with the preset host, and determining if the preset host has been successfully wirelessly connected: if yes, causing the preset host to be operable by the device; and if no, enabling the device to exit the preset mode and enter into a first mode comprising the following steps: determining if the first host has never been paired with the device: if never, enabling the device to pair with the first host, and determine if the first host has been successfully paired: if the first host has been successfully paired, causing the first host to be operable by the device; and if ever, enabling the device to reconnect with the first host, and determine if the first host has been successfully reconnected: if the first host has been successfully reconnected, causing the first host to be operable by the device; and (2) on a condition that the plural hosts comprise the first host and the second host, the method comprising the following steps: enabling the device to enter into the first mode comprising the following steps: determining if the first host has never been paired with the device: if never, enabling the device to pair with the first host, and determine if the first host has been successfully paired: if the first host has been successfully paired, causing the first host to be operable by the device; and if the first host has not been successfully paired, enabling the first host to exit the first mode and enter into a second mode; and if ever, enabling the device to reconnect with the first host, and determine if the first host has been successfully reconnected: if the first host has been successfully reconnected, causing the first host to be operable by the device; and if the first host has not been successfully reconnected, enabling the first host to exit the first mode and enter into the second mode comprising the following steps: determining if the second host has never been paired with the device: if never, enabling the device to pair with the second host, and determine if the second host has been successfully paired: if the second host has been successfully paired, causing the second host to be operable by the device; and if ever, enabling the device to reconnect with the second host, and determining if the second host has been successfully reconnected: if the second host has been successfully reconnected, causing the second host to be operable by the device.

In accordance with another aspect of the present disclosure, a method for enabling a device to connect with plural hosts comprising a first host and a second host is disclosed. The method comprises the following steps: determining if the first host is operable by the device: if yes, causing the first host to be operable by the device; and if no, determining if the second host has never been paired: if the second host has never been paired, enabling the device to pair with the second host and causing the second host to be operable by the device.

In accordance with a further aspect of the present disclosure, a microprocessor for enabling a device to connect with plural hosts comprising a first host and a second host is disclosed. The microprocessor comprises a first determination module configured to enable the device to determine if the first host is to be operable by the device; and a second determination module configured to, when the device has not been successfully connected with the first host, determine if the device has ever been paired with the second host: if yes, enabling the device to pair with the second host, and causing the second host to be operable by the device; and if no, enabling the device to reconnect with the second host, and causing the second host to be operable by the device.

### BRIEF DESCRIPTION OF THE DRAWINGS

The above objectives and advantages of the present invention will become more readily apparent to those ordinarily skilled in the art after reviewing the following detailed descriptions and accompanying drawings, in which:

FIG. 1 is a schematic diagram showing a device and a plurality of hosts that may be connected with;

FIG. 2 is a schematic diagram showing a device according to an embodiment of the present invention;

FIG. 3A is a schematic diagram showing a device without a button switch according to an embodiment of the present invention;

FIG. 3B is a schematic diagram showing a device equipped with a button switch and an indicator light according to an embodiment of the present invention;

FIG. 3C is a schematic diagram showing a device equipped with a button switch and an indicator light according to another embodiment of the present invention;

FIG. 3D is a schematic diagram showing a device equipped with a button switch and two indicator lights according to another embodiment of the present invention;

FIGS. 4A-4D in combined show a flow chart including plural software modules in a processor of a device according to an embodiment of the present invention;

FIGS. 5A-5C in combined show a flow chart including plural software modules in the processor of the device according to another embodiment of the present invention; and

FIGS. 6A-6D in combined show a flow chart including plural software modules in the processor of the device according to further embodiment of the present invention.

### DETAILED DESCRIPTION OF THE PREFERRED EMBODIMENTS

Please refer to all figures of the present invention when reading the following detailed description, wherein all Figures of the present invention demonstrate different embodiments of the present invention by showing examples, and help the skilled person in the art to understand how to implement the present invention. The present examples provide sufficient embodiments to demonstrate the spirit of the present invention, each embodiment does not conflict with the others, and new embodiments can be implemented through an arbitrary combination thereof, i.e., the present invention is not restricted to the embodiments disclosed in the present specification.

The device of the present invention can be a Bluetooth mouse, a Bluetooth keyboard or a Bluetooth joystick. Furthermore, the device includes the bluetooth devices that can operate the hosts such as handwriting tablets, digital tablets (such as digital CAD tablets), and drawing tablets. For simplicity, the Bluetooth mouse is mainly used as the device for the description below.

The term “preset host” refers to a host that is physically connected with/plugged in by the remote adapter; and the term “non-preset host” refers to a host that is not physically connected with/plugged in by the remote adapter. When a non-preset host is physically connected with/plugged in by the remote adapter, the non-preset host serves as or is regarded as a new preset host.

The term “plural hosts” refers to at least two hosts, which may include one preset host and one or at least two non-preset hosts, or may include at least two “non-preset hosts”. The at least two “non-preset hosts” may include a first non-preset host (or a first host), a second non-preset host (or a second host), and may further include a third non-preset host (or a third host), etc.

The present invention can use the memory of the device to store the unique identification code (such as Media Access Control (MAC) Address) of the paired host. For example, the first field of the memory can store the first identification code of the first non-preset host, and the second field of the memory can store the second identification code of the second non-preset host. Therefore, when the user manually presses the button switch on the device one time, it means that the user selects the first non-preset host. At this moment, the device acquires the first identification code stored in the first field and reconnect with the first non-preset host, and the first indicator light is on. If the button switch is pressed again, it means that the user selects the second non-preset host. At this moment, the device acquires the second identification code stored in the second field and reconnect with the second non-preset host, and the second light is on. It should be noted that all fields in the memory may be preset to be blank when the device is ready for sale.

If the memory has only one field (e.g., the first field), the identification code (e.g., the second identification code) of the currently paired host (e.g., the second identification code) will be stored in the first field and thus replace the identification code (e.g., the first identification code) previously stored in the first field.

It should be noted that a preset host indicator can also be disposed on the device. When the device is wirelessly connected with the preset host, the preset host indicator light is on.

The term “first-in-first-out” (FIFO) principle means that, when the memory has plural fields and all of them have stored or been filled with identification codes, on a condition that the device is paired with the X-th non-preset (which has the X-th identification code), the field used to store the X-th identification code at this moment is the one with the earliest stored or filled with the identification code. For example, the memory has first and second fields. Firstly, the first field is used to store the first identification code of the first non-preset host. Secondly, the second field is used to store the second identification code of the second non-preset host. Thirdly, when the device is to pair with a third unpaired host (which has a third identification code), because the first field stores the identification code (which was the first identification code) earlier than the second field does, the first field will be used to store the third identification code, while the second field still stores the second identification code. Fourthly, when the device is to pair with an unfourth paired host (which has a fourth identification code), because the second field stores the identification code (which is the second identification code) earlier than the first field does, the second field will be used to store the fourth identification code, while the first field still stores the third identification code. Although the method in which the first field and the second field are alternately used for storing the identification codes as described above looks like the method of “first-in-first-out”, in fact, the method of alternation only considers the sequence of the first field and the second field to be used without considering the concept of “first-in-first-out”. These two methods differ in the decision of determining which of the fields to be used for storing the identification code.

Regarding the variable N according to the present invention, each time when the device is powered on, the variable N is reset to zero (i.e., N=0). In addition, when a process in the flow chart is executed second time (ie. a same step is executed in the second round or above), the value of N is incremented by one, i.e., N=N+1 in computer language each time.

Regarding the variable P according to the present invention, it serves as a flag indicating which field having stored the identification code is preferentially selected to store a new identification code that replaces the identification code previously stored therein. When the device is shipped out from the factory for sale, the value of P is 0. Each time when the user operates the device to successfully pair with a new host, the value of P will be incremented by one, i.e., P=P+1 in computer language. In this case, the value of P will be odd and even and is used to determine the priority of the fields in the memory to be renewed accordingly.

The terms used in the present invention, if not specifically defined, will be explained by the following terms.

The term “connection” according to the present invention refers to the wireless connection, pairing and reconnection between the device and the host.

The term “wireless connection” means a way that a device can operate a host through a remote adapter physically connected with/plugged in the host. The remote adapter is matched one-to-one with the device.

The term “pairing” means a process that the device sends a pairing command to an unpaired host (also called a new host) and tries to obtain the operation right to the unpaired host to cause the unpaired host to be a non-preset host. It should be noted that the unpaired host is called because its identification code has not been stored in the memory of the device, and the non-preset host is called because its identification code has been stored in the memory of the device. For example, when the user intends to successfully operate the unpaired host through the device, the user causes the device to send a pairing command to the unpaired host via Bluetooth, and waits until a dialog window resulting from a software (such as the built-in Bluetooth software in the Windows system) pops up on the screen of the unpaired host in response to the pairing command. After that, when the user selects “YES” in the dialog window to accept the pairing command, the unpaired device feedbacks its identification code to the device and the memory of the device stores it, and thus the pairing is successful. When the user selects “NO” in the dialog window to reject the pairing command, the unpaired host will feedback nothing, and thus the pairing is not successful. This process is called “pairing”. After the pairing is successful, the unpaired host will be the paired host. At this moment, the user can operate the paired host through the device via Bluetooth.

In order to successfully pair an unpaired host, if there is a preset host near the device, it is recommended that the user unplug the remote adapter that is originally physically connected with/plugged in the preset host, or turn off the power of the preset host. Instead, the user can trigger the pairing process by operating a button switch additionally designed on the device. The operation of the button switch will be explained later.

The term “reconnection” means a process for the device to connect with a non-preset host for a second or more times. For example, when the identification code of the non-preset host (i.e., a paired host) is stored in the memory of the device, and the user intends to use the device to operate this non-preset host, the process that the user tries to cause the device to re-operate the non-preset host is called “reconnection”. As long as the non-preset host is powered on and the distance between it and the device is within a communicable distance via Bluetooth, the non-preset host can be successfully reconnected. At this moment, the pairing process has been omitted, and it is not necessary for the device to send the pairing command to the non-preset host again.

The term “switching” refers to a process that the operation right of the device changes from one to another among a preset host and a single or plural non-preset hosts, or among plural non-preset hosts.

The term “button switch” refers to an element disposed on the device and used to forcibly change the operation right of the device from one to another among a preset host and a non-preset host, or among plural non-preset hosts. The button switch functions like a TV remote controller. For example, when the button switch is pressed, e.g., short-pressed, once, the device is forced to enter into a next mode from the current mode. The disposition of the button switch on the device provides additional functions for the device of the present invention, although it may not involve the key technology of the present invention. In an embodiment where the plural hosts include a preset host and a non-preset host (such as the first non-preset host, or simply called the first host), if the current mode is that the device has the operation right to the preset host, meaning that the device is operable to the preset host, the next mode is that the device has the operation right to the first host, meaning that the device is operable to the first host. If the button switch is pressed, the next mode that the device is operable to the first host takes the place of the current mode that the device is operable to the pre-set host, and thus the next mode is that the device is operable to the pre-set host. In another embodiment where the plural hosts include two non-preset hosts (for example, the first non-preset host and the second non-preset host, or simply called the first host and the second host), if the current mode is that the device is operable to the first host, the next mode is that the device is operable to the second host. If the button switch is pressed, the next mode that the device is operable to the second host takes the place of the current mode, and the next mode is that the device is operable to the first host, accordingly. At this moment, if the switch is short-pressed once again, the next mode that the device is operable to the second host takes the place of the current mode. That is to say, the button switch is designed for the user to forcibly change the operation rights of the device from one to another among the preset host and one or more paired non-preset hosts sequentially.

The term “operation” refers to the operation of the input keys of the device by the user. The input keys include, for example, mouse buttons (e.g., left button and right button), a scroll wheel, or a motion detection sensor (e.g., a trackball, an optical sensor, or an internal gyroscope); or keys of the keyboard (such as: alphabetical keys, numerical keys, function keys, etc.) or a touchpad; or a joystick or any key on a controller of a game console. That is to say, through the “input key” of the device, the user can operate the host that has been wireless connected, paired or reconnected. In an embodiment where the device further includes a button switch, the operation includes the operation to the input key and the button switch by the user.

Regarding the length of “time” or “duration” in the present invention, it is set based on a preferred embodiment. Any value of the length can be chosen and is not limited to the preferred embodiment.

The term “determination module” described in the present invention can be interpreted as a software module, and each determination module can include a set of steps.

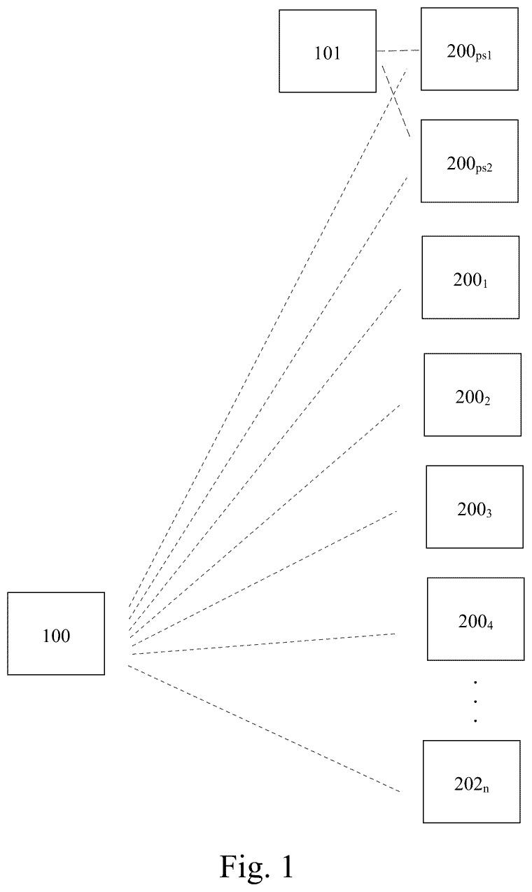

FIG. 1 is a schematic diagram showing a device and a plurality of hosts that it may be connected with. As shown in FIG. 1, the device 100 can connect with one of plural hosts (200ₚₛ₁, 200ₚₛ₂, 200₁, 200₂, 200₃, 200₄, . . . , 200ₙ). If a remote adapter 101 is physically connected with/plugged in the host 200ₚₛ₁ (as indicated by the long dashed line), then the host 200ₚₛ₁ can be a preset host. If the remote adapter 101 is not physically connected with/plugged into any one of the plural hosts (200ₚₛ₁, 200ₚₛ₂, 200₁, 200₂, 200₃, 200₄, . . . , 200ₙ), then any one of the plural hosts (200ₚₛ₁, 200ₚₛ₂, 200₁, 200₂, 200₃, 200₄, . . . , 200ₙ) can be a non-preset host, and the device 100 can pair with or reconnect with the non-preset host (as indicated by the short dashed line).

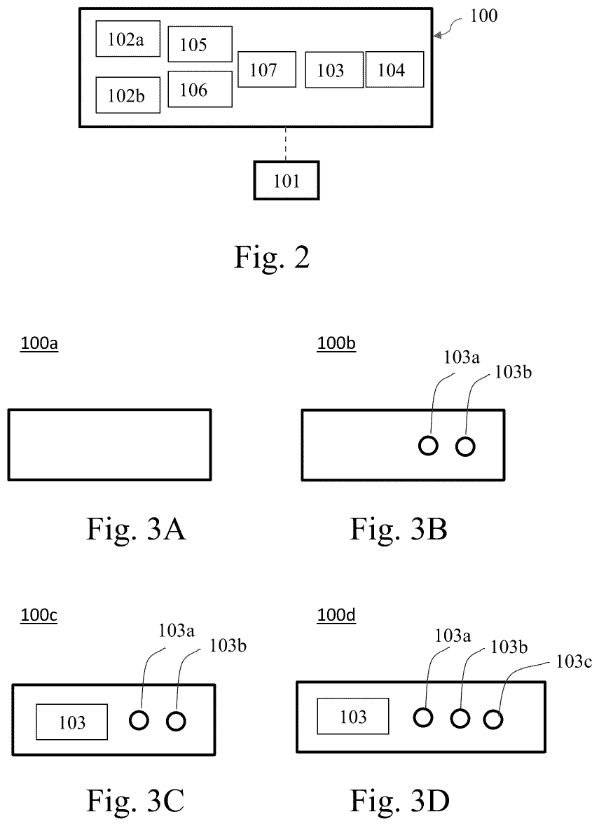

FIG. 2 is a schematic diagram showing a device according to an embodiment of the present invention. As shown in FIG. 2, the device 100 provided by the present invention also includes a remote adapter (or a dongle) 101 matched thereto.

The device 100 includes a button 102ₐ or more (e.g., 102_{b}), a button switch 103 which is optional, a power switch 104, a microprocessor 105, a memory 106, a timer 107 and other required elements omitted in FIG. 2, such as a housing, a battery and a circuit board. However, it should be noted that the device does not include or is equipped with a pairing key, which is not necessary in the present invention. In addition, the device shown in FIG. 2 is only a schematic diagram, and the position of each element does not need to be disposed in the way as shown in FIG. 2. For example, the power switch 104 can be designed on the top surface, side surface, bottom or inside of the housing.

The time or period for the device to conduct a wireless connection, reconnection or pairing is counted by the timer 107. The duration of time can be designed based on demands.

The remote adapter 101 is wirelessly connected with the device 100 via Bluetooth® or Wireless Fidelity (Wi-Fi). For simplicity, the present invention will be described in the form of 2.4 GHz Bluetooth®. The remote adapter 101 may have a USB interface that is going to physically connect with a corresponding USB interface of a host (hereinafter referred to as a preset host) intended to be plugged therein.

FIG. 3A is a schematic diagram showing a device without a button switch according to an embodiment of the present invention. As shown in FIG. 3A, the device 100a is not equipped with any switch and/or indicator light. In this embodiment, the device 100a deals with the connection (i.e., wireless connection, pairing or reconnection) between the device 100a and the hosts according to the determination module disposed in the microprocessor (not shown in FIG. 3A). However, the user cannot know which host is currently operated by the device by visually observing the device 100a, and it is impossible to forcibly switch/change the connection with another paired hosts.

FIG. 3B is a schematic diagram showing a device equipped with two indicator lights according to an embodiment of the present invention. As shown in FIG. 3B, device 100b is equipped with the indicator lights 103a and 103b. In one embodiment of the present invention, during the process of switching the connection between two different paired hosts, the indicator lights 103a and 103b of the device 100 are lit on sequentially, so that the user can visually observe which host is currently connected with and operable by the device 100b. The indicator lights 103a and 103b each can be an LED light.

FIG. 3C is a schematic diagram showing a device equipped with a button switch and two indicator lights according to another embodiment of the present invention. As shown in FIG. 3C, the device 100c is equipped with a button switch 103 and two indicator lights 103a and 103b. In one embodiment of the present invention, during the process of switching the connection between two different paired hosts, the indicator lights 103a and 103b of the device are lit on sequentially, so that the user can visually observe which host is currently connected with and operable by the device 100c. The indicator lights 103a and 103b each can be an LED light.

The indicator lights 103a and 103b display which one of the two paired hosts is connected therewith and is to be operated. For example, if the device 100 is designed to be capable of wirelessly connecting with a preset host (assumed to be the host 200ₚₛ₁ or 200ₚₛ₂, and for simplicity, the host 200ₚₛ₁ is taken as the preset host for example in the following descriptions), and also capable of pairing with the host 200₁ (serving as the first host). In this embodiment, the memory 106 has only one field (not shown in the drawing) for storing one identification code, such as the first identification code ID1 of the first paired host 200₁. When the device 100c is successfully wirelessly connected with the preset host 200ₚₛ₁, the indicator light 103a is lit on and the indicator light 103b is off. When the device 100c is switched to pair with the first host 200₁ and the pairing is currently performing, the indicator light 103a is off and the indicator light 103b is blinking. When the device 100c has successfully paired and connected with the first host 200₁, the indicator light 103a is off and the light 103b is on. It is noted again that, the button switch 103 is optional and not a necessity.

Alternatively, if the device 100c is designed to be capable of pairing with two non-preset hosts (e.g., the first host 200₁ and the second host 200₂). In this embodiment, the memory 106 has two fields (not shown in the drawing) for storing two identification codes, such as the first identification code ID1 of the first paired host 200₁ and the second identification code ID2 of the second host 200₂. When the device 100c is currently pairing with the first host 200₁, the indicator light 103a is blinking and the indicator light 103b is off. When the device 100c has successfully paired with the first host 200₁, the indicator light 103a is on and the indicator light 103b is off. When the device 100c is reconnecting with the first host 200₁, the indicator light 103a is blinking slowly and the indicator light 103b is off. When the device 100c has successfully reconnected with the first host 200₁, the indicator light 103a is on and the indicator light 103b is off. Alternatively, when the device 100c is switched to pair with or reconnect with the second host 200₂, the on and off modes of the indicator lights 103a and 103b will be exchanged. Actually, the on and off modes of the indicator light 103a and 103b can be designed based on demands.

FIG. 3D is a schematic diagram showing a device equipped with a button switch and three indicator lights according to another embodiment of the present invention. As shown in FIG. 3D, the difference between the device 100d and the device 100c shown in FIG. 3C is that the device 100d is further equipped with one more indicator light 103c. Therefore, the device 100d can also be paired with or reconnected with a third host (such as one of the hosts 200₃, 200₄, . . . or 200ₙ). For example, the device 100d is designed to be capable of wirelessly connecting with a preset host 200ₚₛ₁ and also capable of pairing with a first host 200₁ and a second host 200₂. In this embodiment, the memory 106 has two fields (not shown in the drawing) for storing two identification codes, such as the first identification code ID2 of the first paired host 200₁ and the second identification code ID2 of the second host 200₂. Alternatively, the device 100d is designed to be capable of pairing with three non-preset hosts, such as the first host 200₁, the second host 200₂, and a third host such as the host 200₃. In this embodiment, the memory 106 has three fields (not shown in the drawing) for storing three identification codes, such as the first identification code ID1 of the first paired host 200₁, the second identification code ID1 of the second host 200₂ and the third identification code ID3 of the third host 200₃. The on and off modes of the indicator lights 103a, 103b and 103c can correspond to the one described in the previous paragraph, and thus the person skilled in the art can know the on and off modes by analogy from the descriptions in the above embodiments, so it is not necessary to repeatedly described here. It is noted again that, the button switch 103 is optional and not a necessity.

The descriptions of the following embodiments are based on the situation that the device 100 has the button switch 103. It should be noted that, in the embodiment where the device 100 does not have the button switch 103, the steps related to the button switch 103 in the flow chart described below (such as steps S23, S37, S57, S137, S157, S237, S257 and S277) can be skipped.

In addition, the steps in the flow chart described below only show the decision-making steps related to which one of the plural hosts provides the operation right to the device, and does not involve the steps related to the operation of the input key manipulated by the user. The person skilled in the art can understand that, when the device is operated by the user, the steps in the flow chart additionally include a step of determining whether the operation is resulting from the operation of a button switch or an input key. Of course, it can be understood that the steps in the flow chart may further include a step of determining whether the button switch is short-pressed or long-pressed. For example, a short press means an operation to force the device to switch to operate another host, and a long press means to force the device to wirelessly connect with the preset host. Although the steps related to the long press of the button switch are omitted in the flow chart described below, it can be understood how the steps in the flow chart are performed when the button switch is long pressed.

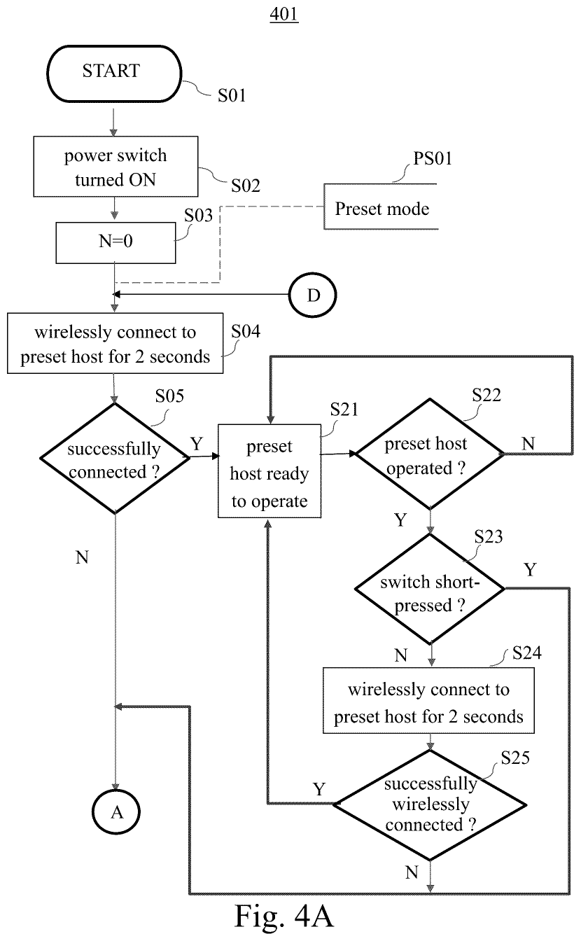

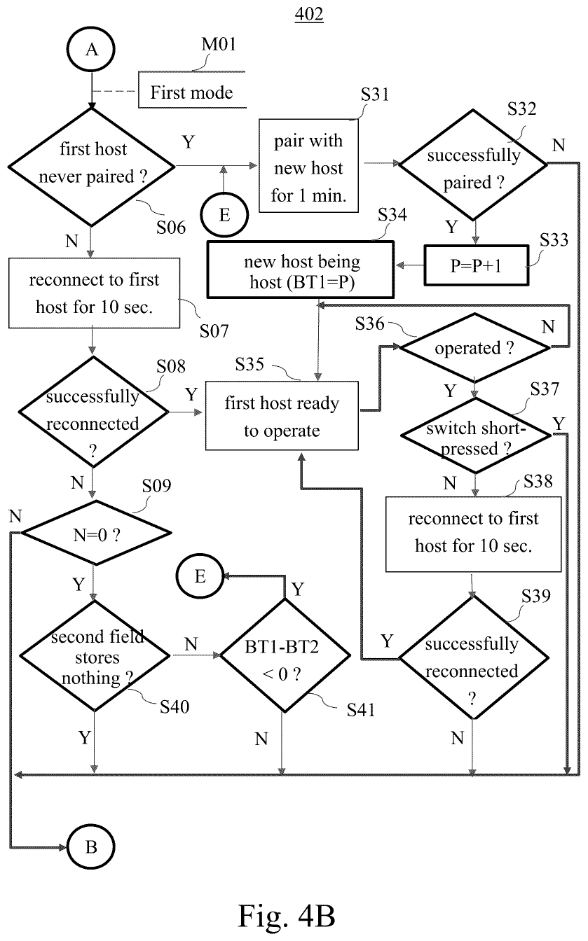

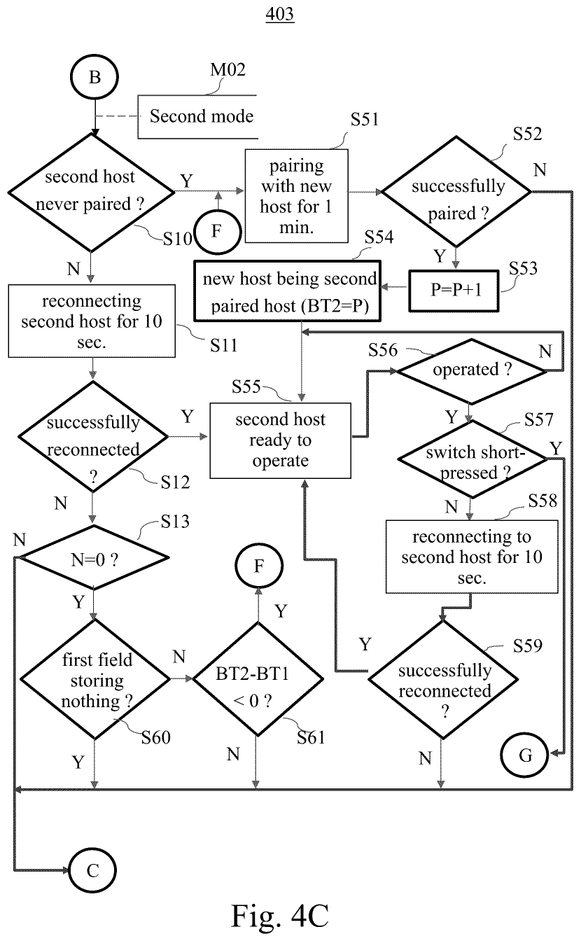

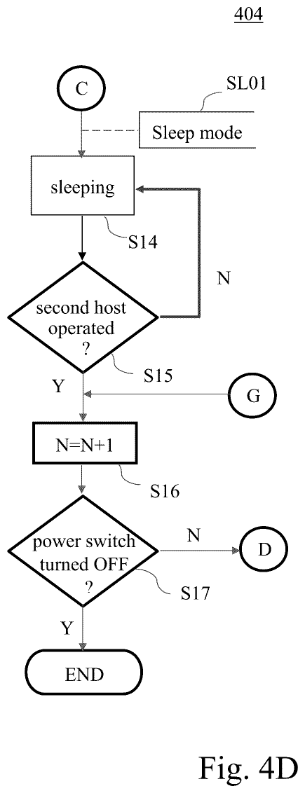

FIGS. 4A-4D show a flow chart including plural software modules in a microprocessor of a device according to an embodiment of the present invention. In this embodiment, the device 100 is designed to be capable of wirelessly connecting with one preset host and pairing with two non-preset hosts. The flow chart includes four determination modules, each of which deals with one mode of the device 100, and these four modes include a preset mode, two modes for pairing with or reconnecting with two non-preset hosts, and a sleep mode.

Please refer to FIG. 4A. The first determination module 401 includes the following steps: the process starts (Step S01), the power switch 104 of the device 100 is turned ON (Step S02), and the value of the variable N is initially set to be 0 (Step S03). At this moment, the device 100 enters into a preset mode (PS01). The device 100 tries to wirelessly connect with a preset host (such as the preset host 200ₚₛ₁) for, e.g., 2 seconds (Step S04), and then it is determined whether the device 100 has successfully wirelessly connected with the preset host 200ₚₛ₁ (Step S05): if not successfully (N), the process enters into the second determination module 402 through the connector \textcircled{A}, and the device 100 enters into a first mode (M01).

Please refer to FIG. 4B. The second determination module 402 includes the following steps: it is determined whether the device 100 has never been paired with a new non-preset host (such as the host 200₁) that is detected by (or can communicate with) the device 100 (Step S06): if No (N), meaning that the device has ever (or not never) been paired with the host 200₁, the host 200₁ serves as (or is regarded as) the first paired host BT1, and the device 100 tries to reconnect with the first paired host BT1 (Step S07). It is determined whether the device 100 has successfully reconnected with the first paired host BT1 (Step S08): if not successfully (N), it is determined whether the variable N is equal to 0 (Step S09): if no (N), the process entering into the third determination module 403 through the connector \textcircled{B}, and the device 100 entering into the second mode (M02).

Please refer to FIG. 4C. The third determination module 403 includes the following steps: it is determined whether the device 100 has never paired with a second non-preset host (such as the host 200₂) that is detected by (or can communicate with) the device 100 (Step S10): if no (N), meaning that the device 100 has ever (i.e. not never) paired with the host 200₂, the host 200₂ serves as (or is regarded as) the second paired host BT2, and the device 100 tries to reconnect with the second paired host BT2 (Step S11). Then, it is determined whether the device 100 has successfully reconnected with the second paired host BT2 (Step S12): if no (N), it is determined whether the variable N is equal to 0 (Step S13): if no (N), the process enters into the fourth determination module 404 through the connector \textcircled{C}, and the device 100 enters into the sleep mode (SL01).

Please refer to FIG. 4D. The fourth determination module 404 includes the following steps: the device 100 goes into a sleep mode (Step S14), and then it is determined whether the device 100 is operated (Step S15): if no (N), the device 100 keeps in a state of sleeping (i.e. the process returns to Step S14); if yes (Y), the value of the variable N is added by 1 (Step S16). Then it is determined whether the power switch 104 of the device 100 is turned off (Step S17): if yes (Y), the fourth determination module 404 ends; and if no (N), the process returns to Step S04 of the preset mode (PS01) through the connector D. At this moment, the user can physically plug the remote adapter in a new host (such as the host 200ₙ) to cause the host 200ₙ to serve as the current preset host.

Please refer to FIG. 4A again. The first determination module 401 further includes the following steps: in step S05, if it is determined to be yes (Y), meaning that the device has successfully wirelessly connected with the preset host 200ₚₛ₁, the device 100 is ready to be operated by the user (Step S21). Then it is determined whether the device 100 is operated by the user (Step S22): if no (N), the device 100 keeps in a state ready to operate the preset host 200ₚₛ₁ by the user (i.e., the process returns to Step S21); if yes (Y), it is determined whether the operation is a short press made onto the button switch 103 (Step S23): if yes (Y), the process enters into the second determination module 402 through the connector \textcircled{A}, and the device 100 enters into the first mode (M01); if no (N), the device 100 tries to wirelessly connect with the preset host 200ₚₛ₁ for, e.g., 2 seconds (Step S24), and it is determined whether the device 100 has successfully wirelessly connected with the preset host 200ₚₛ₁ (Step S25): if no (N), the process enters into the second determination module 402 through the connector \textcircled{A}, and the device 100 enters into the first mode (M01); if yes (Y), the device 100 keeps in a state ready to operate the preset host 200ₚₛ₁ by the user (i.e., the process returns to Step S21).

Please refer to FIG. 4B again. The second determination module 402 further includes the following steps: in Step S06, if it is determined to be yes (Y), the device 100 tries to pair with the first new host for, e.g., 1 minute (Step S31), and it is determined whether the device 100 has successful paired with the new host 200₁ (Step S32): if no (N), the process enters into the third determination module 403 through the connector \textcircled{B}, and the device 100 enters into the second mode (M02); if yes (Y), the value of the variable P is added by 1 (Step S33), and the first new host 200₁ serves as the first paired host BT1, then the value of BT1 is set to be equal to the current value of P (Step S34), and the first paired host BT1 is ready to be operated by the device 100 (Step S35). At this moment, the first field of the memory 106 stores the first identification code ID1 of the first paired host BT1 which is now the host 200₁. Then, it is determined whether the device 100 is operated by the user (Step S36): if no (N), the device 100 keeps in a state ready to operate the first paired host BT1 (Step S35); if yes (Y), it is determined whether the operation is a short press made onto the button switch 103 (Step S37): if yes (Y), the process enters into the third determination module 403 through the connector \textcircled{B}; if no (N), the device 100 tries to reconnect with the first paired host BT1 for, e.g., 10 seconds (Step S38), and it is determined whether the device 100 has successfully reconnected with the first paired host BT1 (Step S25): if no (N), the process enters into the third determination module 403 through the connector \textcircled{B}; if yes (Y), the device 100 keeps in a state ready to operate the first paired host BT1 (Step S35).

The second determination module 402 further includes the following steps: in step S08, if it is determined to be yes (Y), the process goes through Step S35 and the subsequent steps; if no (N), it is determined if the value of N is equal to 0 (step S09): is yes (Y), it is determined whether the memory 106 stores nothing (Step S40): if yes (Y), the process enters into the third determination module 403 through the connector \textcircled{B}; if no (N), it is determined whether the value of BT1 minus that of BT2 is less than 0 (Step S41): If no (N), the process enters into the third determination module 403 through the connector \textcircled{B}; if yes (Y), the steps including Step S31 and the subsequent steps are performed through the connector \textcircled{E} to make the device 100 to pair with a new host.

Please refer to FIG. 4C. The third determination module 403 further includes the following steps: in Step S10, if it is determined to be yes (Y), the device tries to pair with a second new host 200₂ for, e.g., 1 minute (Step S51), and it is determined whether the device has successfully paired with the second new host 200₂ (Step S52): if no (N), the process enters into the fourth determination module 404 through the connector \textcircled{C}; if yes (Y), the value of the variable P is added by 1 (Step S53), and the second new host 200₂ serves as the second paired host BT2, the value of BT2 is set to be equal to the current value of P (Step S54), and the second paired host BT2 is ready to be operated by the device 100 (Step S55). At this moment, the second field of the memory 106 stores the second identification code ID2 of the second paired host BT2 which is now the host 200₂. Then, it is determined whether the device 100 is operated by the user (Step S56): if no (N), the device 100 keeps in a state ready to operate the second paired host BT2 (Step S55); if yes (Y), it is determined whether the operation is a short press made onto the button switch 103 (Step S57): if yes (Y), the process enters into the fourth determination module 404 through the connector \textcircled{C}; if no (N), the device tries to reconnect with the second paired host BT2 for, e.g., 10 seconds (Step S58), and it is determined whether the device 100 has successfully reconnected with the second paired host BT2 (Step S59): if no (N), the process enters into the fourth determination module 404 through the connector \textcircled{C}; if yes (Y), the process goes through Step S55 and the subsequent steps.

The third determination module 403 further includes the following steps: in Step 12, if it is determined to be yes (Y), the process goes through Step S55 and the subsequent steps; if no (Y), it is determined whether the value of N is equal to 0 (S13): if yes (Y), it is determined whether the first field of the memory 106 stores nothing (Step S60): if yes (Y), the process enters into the fourth determination module 404 through the connector \textcircled{C}; if no (N), it is determined whether the value of BT2 minus the value of BT1 is less than 0 (Step S61): if yes (Y), the process goes through Step S51 and the subsequent steps through the connector \textcircled{F} to make the device 100 try to pair with a new host; if no (N), the process enters into the fourth determination module 404 through the connector \textcircled{C}.

### Example 1

When the device 100 is used/operated for the first time, in thus situation, it is to explain how the process goes through the first, second and third determination modules when either the first preset host 200ₚₛ₁ is successfully wirelessly connected, the first paired host is successfully paired, or the second paired host is successfully paired.

Please refer to FIGS. 4A-4D again. When the device 100 is used/operated for the first time, the power switch 104 is turned on (Step S02), the variables are preset as N=0, P=0, and BT1=BT2=0. For simplicity, in the following Table 1, the descriptions in some steps are omitted, but these omissions will not cause any misunderstanding to the person skilled in the art.

TABLE 1

| | | Execution/ | |
|---|---|---|---|
| Deter- | | Deter- | |
| mination | | mination | |
| module | Step | Result | Example or Remark |
| 401 | S03 | N = 0 | the first determination module |
| (first | | | 401 is performed, and the device |
| round) | | | enters into the preset mode PS01 |
| | S04 | the device tries | the remote adaptor 101 is |
| | | to wilrelessly | physically connected with the |
| | | connect with the | host 200ₚₛ₁, and the preset host |
| | | preset host 200ₚₛ₁ | 200ₚₛ₁ is powered on |
| | S05 | Y | the device has wirelessly |
| | | | successfully connected with the |
| | | | preset host 200ₚₛ₁ |
| | S21 | the device is | the device keeps in a state ready |
| | | standing by | to operate the preset host 200ₚₛ₁ |
| | S22 | N | the device 100 is not operated by |
| | | | the user |
| | S21 | The device is | the device 100 keeps in a state |
| | | standing by | ready to operate the preset host |
| | | | 200ₚₛ₁ |
| | S22 | Y | the device 100 is operated by the |
| | | | user |
| | S23 | Y | the button switch 103 has been |
| | | | short-pressed by the user, so that |
| | | | the process is forced to enter into |
| | | | the second determination module |
| | | | 402, and the device 100 enters |
| | | | into the first mode M01 |
| 402 | S06 | Y | a new host 200₁ is turned on and |
| (in a | | | is located adjacent to the device |
| first | | | 100 |
| round) | S32 | Y | the device has been successfully |
| | | | paired with the host 200₁ |
| | S33 | P = 0 + 1 = 1 | setting P = 0 when Step S06 is |
| | | (which is an | performed at the very first time, |
| | | odd number) | and after step S33 is executed, P |
| | | | is added by 1 |
| | S34 | BT1 = P = 1 | the first field of the memory 106 |
| | | (which is an | stores the identification code ID1 |
| | | odd number) | of the host 200₁ that serves as the |
| | | | first paired host, and then, when |
| | | | the variable P is an odd number, |
| | | | the current paired host servies as |
| | | | the first paired host |
| | S36 | Y | the device 100 is operated by the |
| | | | user |
| | S37 | N | the device 10 tries to reconnect |
| | | | with the first paired host |
| | S39 | Y | the first paired host is ready to be |
| | | | operated by the device 100 |
| | S36 | Y | the device 100 is operated by the |
| | | | user |
| | S37 | Y | the button switch 103 is pressed |
| | | | to force the third determinatinon |
| | | | module 403 to be performed, and |
| | | | thus the pocess enters into the |
| | | | second module M02 |
| 403 | S10 | Y | a new host 200₂ is powerd on and |
| (in a | | | is adjacent to the device 100 |
| first | S52 | Y | successfully pair with the |
| round) | | | newhost 200₂ |
| | S53 | P = 1 + 1 = 2 | before Step S53 is executed, P = 1, |
| | | (an odd number) | and after it is executed, P is added |
| | | | by 1 |
| | S54 | BT2 = P = 2 | the new host 200₂ serves as the |
| | | (an even number) | second paired host BT2, and the |
| | | | second field of the memory stores |
| | | | the IDof the host 200₂ |
| | | | at any time when the vairalbe P is |
| | | | an even number, the current |
| | | | paired host servies the second |
| | | | paired host |
| | S56 | Y | the device 100 is operated by the |
| | | | user |
| | S57 | N | Reconnect with the second paired |
| | | | host, i.e. the host 200₂ |
| | S59 | Y | the second paired host 200₂ is |
| | | | ready to be operated |
| | S56 | Y | the device 100 is operated by the |
| | | | user |
| | S57 | Y | the button switch 103 is short- |
| | | | pressed so that the process is |
| | | | forced to enter into the fourth |
| | | | determination module 404, and |
| | | | the device 100 enters into the |
| | | | sleep mode SL01 |
| 404 | S15 | Y | the device 100 is operated by the |
| (in a | | | user |
| first | S16 | N = 2 | before Step S03, N = 1, and after it |
| round) | | | is executed, N is added by 1 |
| | S17 | N | power switche is still turned ON, |
| | | | and the process returns to Step |
| | | | S04 |
| 401 | S04 | the device tries | the remote adaptor 101 is |
| (in a | | to wilrelessly | physically connected with the |
| second | | connect with the | host 200ₚₛ₂, and the preset host |
| round) | | preset host 200ₚₛ₂ | 200ₚₛ₂ is powered on |
| | S05 | Y | The device 100 successfully |
| | | | wirelessly connects with the |
| | | | perset host 200ₚₛ₂ |
| | S21 | The device is | the device 100 keeps in a state |
| | | standing by | ready to operate the preset host |
| | | | 200ₚₛ₁ |
| | S22 | Y | the device 100 is operated by the |
| | | | user |
| | S23 | Y | the button switch 103 has been |
| | | | short-pressed by the user, so that |
| | | | the process is forced to enter into |
| | | | the second determination module |
| | | | 402, and the device 100 enters |
| | | | into the first mode M01 |
| 402 | S06 | Y | a new host 200₃ is turned on and |
| (in a | | | is located adjacent to the device |
| second | | | 100 |
| round) | S32 | Y | the device has been successfully |
| | | | paired with the host 200₃ |
| | S33 | P = 2 + 1 = 3 | when the step S53 was previously |
| | | (an odd number) | executed, P = 2, and after step S33 |
| | | | is executed, P is added by 1 |
| | S34 | BT1 = P = 3 | because of the FIFO rule, “P |
| | | (an odd number) | being 3” replaces “P being 1”, the |
| | | | identification code₃ replaces the |
| | | | identification code₁ stored in the |
| | | | first field of the memory 106, |
| | | | meaning that the host 200₃ serves |
| | | | as the first paired host now |
| | S36 | Y | the device 100 is operated by the |
| | | | user |
| | S37 | Y | the button switch 103 is short- |
| | | | pressed so that the process is |
| | | | forced to enter into the third |
| | | | determination module 403, and |
| | | | the device 100 enters into the |
| | | | second mode M02 |

After the process enters into the second mode M02, it finally enters into the sleep mode SL01. The power switch 104 is turned off, and thus the process ends.

### Rule of First-In-First-Out (FIFO)

The rule of FIFO is that, when the memory has a plurality of fields for storing identification codes, the identification code stored in the memory first will be erased first. According to an embodiment of the present invention, the sequence that the fields of the memory 106 for storing the identification code thereinto and erasing it therefrom is determined by comparing the value of BT1 and the value of BT2, which two values use the count of the variable P, as shown in Example 2 below.

### Example 2

When the device 100 is used by the user for the first time, on a condition that the device 100 has failed to wirelessly connect with the first preset host 200 psi when the process enters into the first determination module 401, the device 100 has failed to pair with the first paired host when the process enters into the second determination module 402, and finally the device 100 has successful paired with the second paired host when the process enters into the third determination module 403.

Please refer to FIGS. 4A-4D again. When the device 100 is operated for the first time, the power switch 104 is turned on by the user (Step S02), and the initial values of the respective variables are as follows: N=0, P=0 and BT1=BT2=0. For simplicity, the descriptions for the process starts directly from the steps described in the third determination module 403. Likewise, in the following Table 2, the descriptions in some steps are omitted, but these omissions will not cause any misunderstanding to the person skilled in the art.

TABLE 2

| Determination | | Execution | |
|---|---|---|---|
| module | Step | Result | Example or Remark |
| 403 | S10 | Y | pairing with a new host 200₃ for the first |
| (in the | | | time |
| first | S52 | Y | successfully paired with the new host |
| round) | | | 200₃ |
| | S53 | P = 0 + 1 = 1 | initially P = 0, and after step S53 is |
| | | (an odd number) | executed, P is added by 1 |
| | S54 | BT2 = P = 1 | host 200₃ serves as the second paired |
| | | (an odd number) | host, and the second filed of the memory |
| | | | stores the identification code of the host |
| | | | 200₃ as the second identification code |
| | | | ID2 |
| | | | (remark: at this moment there is no first |
| | | | paired host, and the first field of the |
| | | | memory stores no identification code, |
| | | | and after that, when the variable P is an |
| | | | odd number, the current paired host |
| | | | serves as the second paired host) |
| 403-404 | going | | (the details are omitted herein) |
| (in the | through | | |
| first | S55-S59, | | |
| round), | [symbol] , S14- | | |
| and 401- | S17, [symbol] , | | |
| 402 | S04-S05, | | |
| (in the | [symbol] | | |
| second | | | |
| round) | | | |
| 402 | S06 | N | (the details are omitted herein) |
| (in the | S07-S09 | | (the details are omitted herein) |
| second | S40 | N | identification code ID2 has ever been |
| round) | | | stored in the second field |
| | S41 | Y | BT1 = 0, BT2 = 1 |
| | | | BT1 − BT2 = −1 (i.e. <0) |
| | [symbol] , S31 | Y | pairing with a new host 2004 for the first |
| | | | time |
| | S32 | Y | successfully paired the new host 200₄ |
| | S33 | P = 1 + 1 = 2 | previously P = 1, and after step S33 is |
| | | (an even number) | executed, P is added by 1 |
| | S34 | BT1 = P = 2 | the host 200₄ serves as the first paired |
| | | (an even number) | host, and the first field of the memory |
| | | | stores the identification number of the |
| | | | host 2004 as the first identification |
| | | | number ID1 |
| | | | (remark: time for the second field of the |
| | | | memory storing the second |
| | | | identification ID2 is earlier than that for |
| | | | the first field storing the first |
| | | | identification number ID1, and |
| | | | therefore, next time the device is newly |
| | | | pairing with a new host, the second field |
| | | | will be erased/overwritten first, and after |
| | | | that, when the variable P is an even |
| | | | number, the current paired host servies |
| | | | as the first paired host) |
| | S35-S39, | | (the details are omitted herein) |
| | [symbol] | | |
| 403 | S10-S13 | | (the details are omitted herein) |
| (in the | S60 | N | identification code ID1 has ever been |
| thrid | | | stored in the first field |
| round) | S61 | Y | BT1 = 2, BT2 = 1 |
| | | | BT2 − BT1 = −1 (i.e. <0) |
| | [symbol] , S51 | | the device pairing with a new host 200₅ |
| | | | for the first time |
| | S52 | Y | successfully paired with the new host |
| | | | 200₅ |
| | S53 | P = 2 + 1 = 3 | previously P = 2, and after step S53 is |
| | | (an odd number) | executed, P is added by 1 |
| | S54 | BT2 = P = 3 | the new host 200₅ serves as the second |
| | | (an odd number) | paired host |
| | | | (i.e. because time for the second field of |
| | | | the memory storing the second |
| | | | identification ID2 is earlier than that for |
| | | | the first field storing the first |
| | | | identification number ID1, when the |
| | | | device has successfully paired with the |
| | | | host 200₅, the ID2, which is previously |
| | | | the identification number of the host |
| | | | 200₃, stored in the second field of the |
| | | | memeory will be overwritten/replaced |
| | | | by the newly paired host 2005 first, |
| | | | because of the FIFO rule) |

Because there are quite a lot of combinations of steps in the flow charts when referring to FIG. 4A-4C according to the actual situation, the person skilled in the art can understand and implement each of the combinations by analogy based on the flow charts shown in FIG. 4A-4C. It is not necessary to describe all combinations of steps in the process.

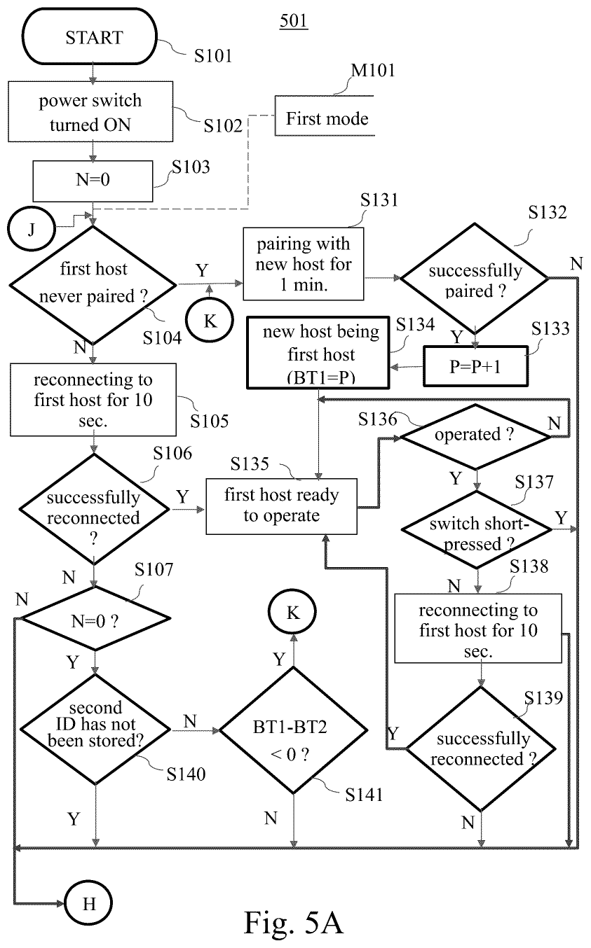

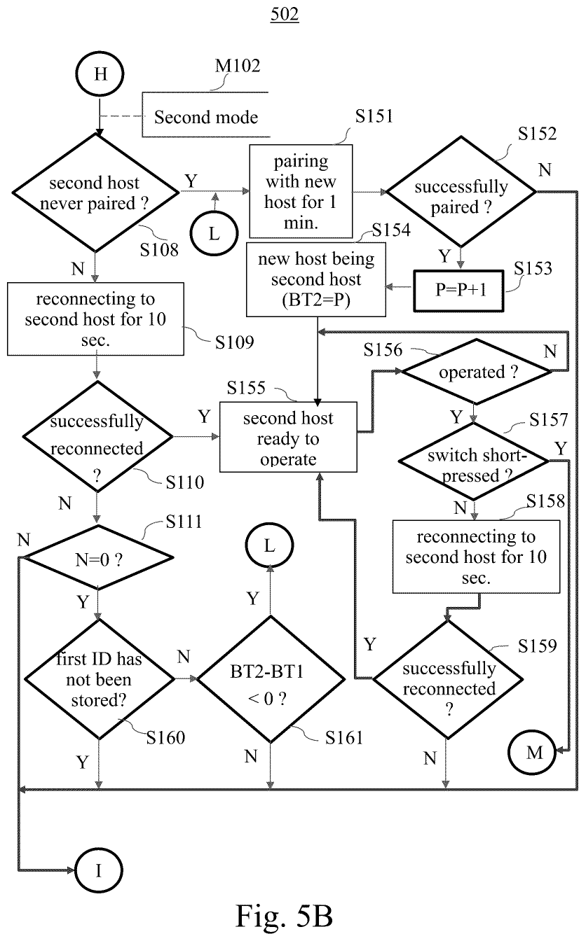

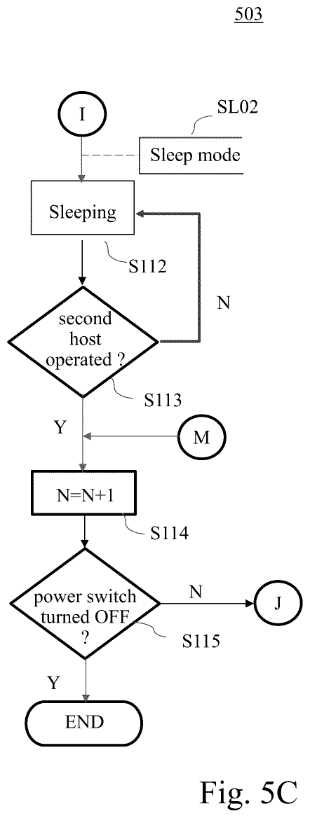

The combination of FIGS. 5A-5C shows a flow chart including plural software modules in the microprocessor of the device according to another embodiment of the present invention. In this embodiment, the device 100 is suitable for/capable of pairing with two non-preset hosts but no preset host. The flow chart includes three determination modules, each of which processes a mode of the device 100, wherein these modules include two modes for pairing and/or reconnection, and one mode for sleeping/standing by. Accordingly, in comparison with the processes shown in FIGS. 4A-4D, the process according to this embodiment does not have the determination module for the preset mode.

Please refer to FIG. 5A. The first determination module 501 includes the following steps: the process starts (Step S101), the power switch 104 of the device 100 is turned ON (Step S102), and the value of the variable N is initially set to be 0 (Step S103). At this moment, the device 100 enters into a first mode (M101). Then, it is determined whether the device 100 has never been paired with a newly detected first host (such as the host 200₁) (Step S104): if no (N), meaning that the device has ever paired with the newly detected first host and so the newly detected first host continues to serve as the first paired host BT1, then the device 100 tries to reconnect with the paired host BT1 at this moment (Step S105), and then it is determined whether the device 100 has successfully reconnected with the first paired host BT1 (Step S106): if not successfully (N), it is determined whether the value of N is 0 (Step S107); if no (N), the process enters into the second determination module 502 through the connector \textcircled{H}, and the device 100 enters into the second mode (M102).

Please refer to FIG. 5B. The second determination module 502 includes the following steps: it is determined whether the device 100 has never been paired with a newly detected second host (such as the host 200₂) (Step S108); if no (N), it means that the device 100 has ever paired with the newly detected second host and so the newly detected second host continues to serve as the second paired host BT2. At this moment, the device 100 tries to reconnect with the second paired host BT2 (Step S109), and it is determined whether the device 100 has successfully reconnected with the second paired host BT2 (Step S110): if not successfully (N), it is determined whether the value of N is 0 (Step S111): if no (N), the process enters into the third determination module 503 through the connector \textcircled{I}, and the device 100 enters into the sleep mode (SL02).

Please refer to FIG. 5C. The third determination module 503 includes the following steps: the device 100 sleeps (Step S112), and then it is determined whether the device 100 is operated by a user (Step S113); if no (N), the device 100 keeps in a state of sleeping (Step S112)); if yes (Y), the value of the variable N is added by 1 (Step S114). Then, it is determined whether the power switch 104 of the device 100 is turned off (Step S115): if yes (Y), the third determination module 503 ends; if no (N), the process returns to Step S104 of the first mode (M101) through the connector \textcircled{J}.

Please refer to FIG. 5A again. The first determination module 501 further includes the following steps: in Step S104, if it is determined to be yes (Y), the device 100 tries to pair the first new host for, e.g., 1 minute (Step S131), and it is determined whether the device 100 has successfully paired with the first new host 200₁ (Step S132): if not successfully (N), the process enters into the second determination module 502 through the connector \textcircled{H}; if successfully (Y), the value of variable P is added by 1 (Step S133), and the first new host 200₁ serves as the first paired host (BT1), the code value of BT1 is set to be equal to the current value of P (Step S134), and the device 100 is enabled to operate the first paired host BT1 (Step S135). At this moment, the one of the fields of the memory 106 decided according to the aforementioned FIFO rule stores the first identification code of the host 200₁ as ID1. Then, it is determined whether the device 100 is operated by a user (Step S136): if no (N), the device 100 keeps in a state ready to operate the first paired host BT1 (Step S135); if yes (Y), it is determined whether the operation is a short press made onto the button switch 103 (Step S137): if yes (Y), the process enters into the second determination module 502 through the connector \textcircled{H}; if no (N), the device 100 tries to reconnect with the first paired host BT1 for, e.g., 10 seconds (Step S138), and it is determined whether the device 100 has successfully reconnected with the first paired host BT1 (Step S139): if no (N), the process enters into the second determination module 502 through the connector \textcircled{H}; if yes (Y), the device 100 keeps in a state ready to operate the first paired host BT1 (Step S135).

The first determination module 501 further includes the following steps: if it is determined to be yes (Y) in Step S106, the process goes through Step S135 and the subsequent steps as described above; or when it is determined to be yes (Y) in Step S107, it is determined whether the second identification number ID2 has not been stored in any field of memory 106 (Step S140): if not stored (Y), the process enters into the second determination module 502 through the connector \textcircled{H}; if stored (N), it is determined whether the value of BT1 minus the value of BT2 is less than 0 (Step S141): if no (N), the process enters into the subsequent steps of the second determination module 502 through the connector \textcircled{H}; or if yes (Y), the process executes Step S131 and the subsequent steps through the connector \textcircled{K}.

Please refer to FIG. 5B again. The second determination module 502 further includes the following steps: when it is determined to be yes (Y) in Step S108, the device 100 tries to pair with the second new host 200₂ for, e.g., 1 minute (Step S151), and it is determined whether the device has successfully paired with the second new host 200₂ (Step S152): if no (N), the process enters into the second determination module 502 through the connector \textcircled{H}; if yes (Y), the value of the variable P is added by 1 (Step S153), and the second new host 200₂ serves the second paired host (BT2), the code value of BT2 is set to be equal to the current value of P (Step S154), and the device 100 keeps in a state ready to operate the second paired host BT2 (Step S155). At this moment, the one of the fields of the memory 106 decided according to the aforementioned FIFO rule stores the second identification code of the host 200₂ as ID2. Then, it is determined whether the device 100 is operated by a user (Step S156): if no (N), the device 100 keeps in a state ready to operate the second paired host BT2 (Step S155); if yes (Y), it is determined whether the operation is a short press made onto the button switch 103 (Step S157): if yes (Y), the process enters into the second determination module 502 through the connector \textcircled{I}; if no (N), the device 100 tries to reconnect with the second paired host BT2 for, e.g., 10 seconds (Step S158), and it is determined whether the device 100 has successfully reconnected with the second paired host BT2 (Step S159): if no (N), the process enters into the third determination module 503 through the connector \textcircled{I}; if yes (Y), the device 100 keeps in a state ready to operate the second paired host BT2 (Step S155).

The second determination module 502 further includes the following steps: in Step S110, if it is determined to be yes (Y), the process goes through Step S155 and the subsequent steps; if it is determined to be no (N) in Step S110, it is determined whether the value of N is 0 (Step S111): if yes (Y), it is determined whether the first identification code ID1 has not been stored in the memory 106 (Step S160): if not stored (Y), the device 100 enters into the third determination module 503 through the connector \textcircled{I}; if no (N), it is determining whether the value of BT2 minus the value of BT1 is less than 0 (Step S161): If no (N), the device 100 enters into the third determination module 503 through the connector \textcircled{I}; if yes (Y), the process executes Step S151 and the subsequent steps through the connector \textcircled{L}.

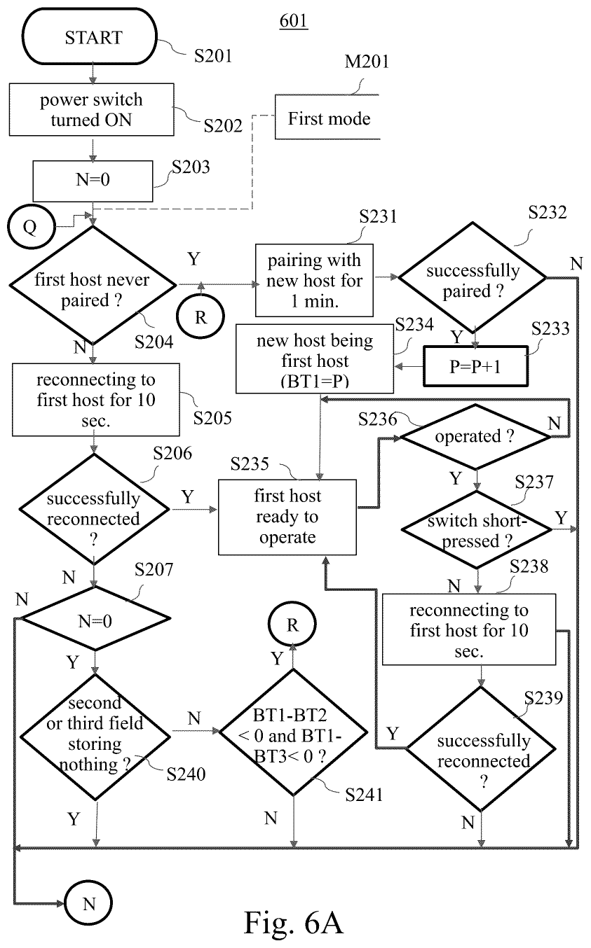

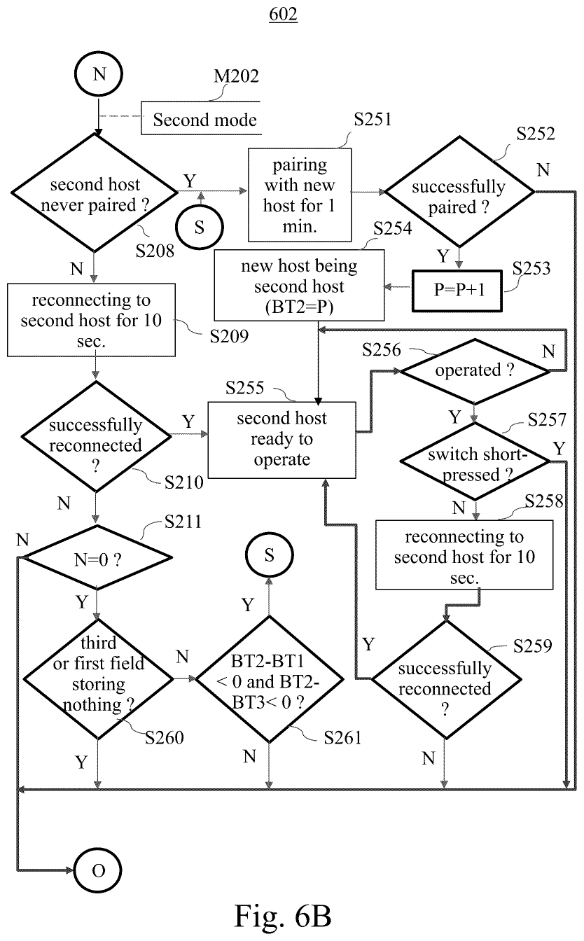

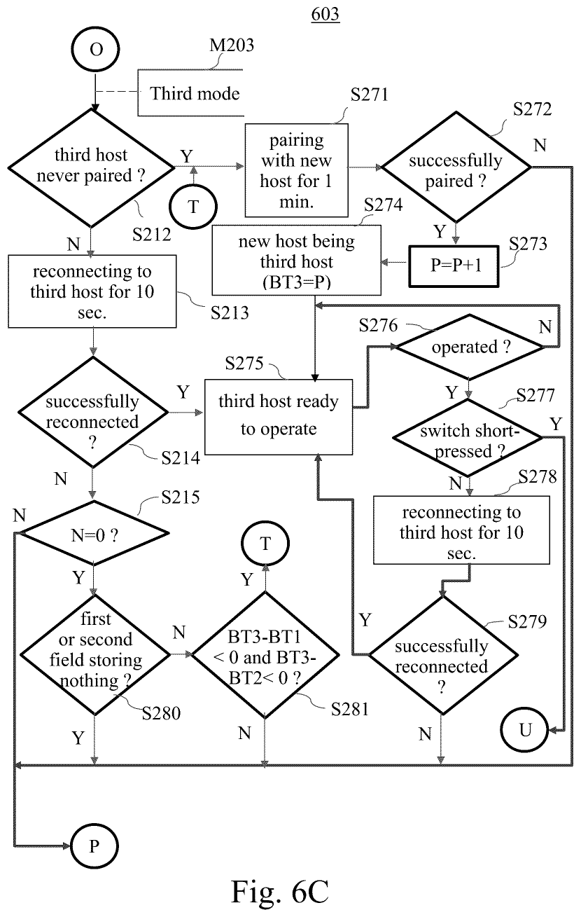

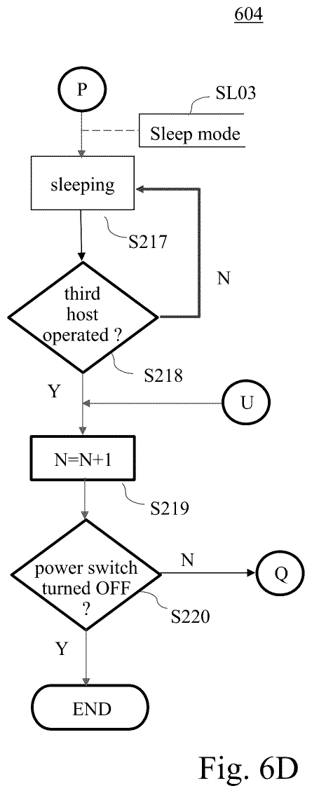

The combination of FIGS. 6A-6D shows a flow chart including a plurality of software modules in the microprocessor of the device according to another embodiment of the present invention. In this embodiment, the device 100 is suitable for/capable of pairing with three non-preset hosts but no preset host. The flow chart includes four determination modules, each of which processes a mode of the device 100, and these modes include three modes for pairing and/or reconnection with the three non-preset hosts, and a sleep mode for standing by. In comparison with the flow chart shown in FIGS. 5A-5C, the flow chart according to this embodiment has an additional determination module for pairing and/or reconnection with the third non-preset host.

Please refer to FIG. 6A. The first determination module 601 includes the following steps: the process starts (Step S201), the power switch 104 of the device 100 is turned ON by a user (Step S202), the value of the variable N is initially 0 (Step S203), and then the device 100 enters into the first mode (M201). It is determined whether the device 100 has never been paired with a newly detected first host (such as the host 200₁) (Step S204): if no (N), meaning that the device 100 has ever paired with the newly detected first host and so the newly detected first host continues to serve as the first paired host BT1, then the device 100 tries to reconnect with the first paired host BT1 (Step S205), and it is determined whether the device 100 has successfully reconnected with the first paired host BT1 (Step S206); if not successfully (N), it is determined whether the value of N is 0 (Step S207); if no (N), the process enters into the second determination module 602 through the connector. At this moment, the device 100 enters into the second mode (M202).

Please refer to FIG. 6B. The second determination module 602 includes the following steps: it is determined whether the device 100 has never been paired with a newly detected second host (such as the host 200₂) (Step S208); if no (N), it means that the device 100 has ever paired with the newly detected second host and so the newly detected second host continues to serve as the second paired host BT2. At this moment, the device 100 tries to reconnect with the second paired host BT2 (Step S209), and it is determined whether the device 100 has successfully reconnected with the second paired host BT2 (Step S210): if no (N), it is determined whether the value of N is 0 (Step S211): if no (N), the process enters into the third determination module 603 through the connector \textcircled{O}. At this moment, the device 100 enters into the third mode (M203).

Please refer to FIG. 6C. The third determination module 603 includes the following steps: it is determined whether the device 100 has never been paired with a newly detected third host (such as the host 200₃) (Step S212), if no (N), meaning that the device 100 has ever paired with the newly detected third host and so the newly detected third host continues to serve as the third paired host BT3. At this moment, the device 100 tries to reconnect with the third paired host BT3 (Step S213), and it is determined whether the device 100 has successfully reconnected with the third paired host BT3 (Step S214): if no (N), it is determined whether the value of N is 0 (Step S215): if no (N), the process enters into the fourth determination module 604 through the connector \textcircled{P}, and the device 100 enters into the sleep mode at this moment (SL03).

Please refer to FIG. 6D. The fourth determination module 604 includes the following steps: the device 100 sleeps (Step S217), and it is determined whether the device 100 is operated by the user (Step S218); if no (N), the device 100 keeps in a state of sleeping (Step S217)); if yes (Y), the value of the variable N is added by 1 (Step S219), and then it is determined whether the power switch 104 of the device 100 is turned off by a user (Step S220): if yes (Y), the fourth determination module 604 ends; if no (N), the process returns to Step S204 of the first mode (M201) through the connector \textcircled{Q}.

Referring to FIG. 6A again. The first determination module 601 further includes the following steps: if it is determined to be yes (Y) in Step S204, the device 100 tries to pair with the first new host for, e.g., 1 minute (Step S231), and it is determined whether the device 100 has successfully paired with the first new host 200₁ (Step S232): if no (N), the process enters into the second determination module 602 through the connector \textcircled{N}; if yes (Y), the value of variable P is added by 1 (Step S233), and the first new host 200₁ continues to serve as the paired first host BT1, and the code value of BT1 is set to be equal to the current value of P (Step S234), and the first paired host BT1 is ready to be operated by the device 100 (Step S235); at this moment, the one of the fields of the memory 106 decided according to the aforementioned FIFO principle to store the first identification code of the host 200₁ as ID1. Then, it is determined whether the device 100 is operated by a user (Step S236): if no (N), the device 100 keeps in a state ready to operate the first paired host BT1 (Step S235); if yes (Y), it is determined whether the operation is a short press made onto the button switch 103 (Step S237): if yes (Y), the process enters into the second determination module 602 through the connector \textcircled{N}; if no (N), the device 100 tries to reconnect with the first paired host BT1 for, e.g., 10 seconds (Step S238), and it is determined whether the device 100 has successfully reconnected with the first paired host BT1 (Step S239): if no (N), the process enters into the second determination module 602 through the connector \textcircled{N}; if yes (Y), the device 100 keeps in a state ready to operate the first paired host BT1 (Step S235).

The first determination module 601 further includes the following steps: if it is determined to be yes (Y) in Step S206, the process goes through Steps 235 and the subsequent steps; and if it is determined to be yes (Y) in Step S207, it is determined whether the second or third identification code is not stored in the field of memory 106 (Step S140): if yes (Y), the process enters into the second determination module 602 through the connector \textcircled{N}; if no (N), it is determined both whether the value of BT1 minus the value of BT2 is less than 0 and whether the value of BT1 minus the value of BT3 is less than 0 (Step S241): if no (N), the process enters into the second determination module 602 and the subsequent steps through the connector \textcircled{N}; if yes (Y), the process executes Step S231 and the subsequent steps through the connector ®.

Please refer to FIG. 6B again. The second determination module 602 further includes the following steps: if it is determined to be yes (Y) in Step S208, the device 100 tries to pair with a second new host 200₂ for, e.g., 1 minute (Step S251), and it is determined whether the device 100 has successfully paired with the second new host 200₂ (Step S252): if no (N), the process enters into the third determination module 603 through the connector \textcircled{O}; if yes (Y), the value of variable P is added by 1 (Step S253), the second new host 200₂ continues to serve as the second paired host BT2, and the code value of BT2 is set to be equal to the current value of P (Step S254), and then the device 100 is ready to operate the second paired host BT2 (Step S255); at this moment, the one of the fields of the memory 106 decided according to the aforementioned FIFO principle to store the second identification code ID2 of the host 200₂. Then, it is determined whether the device 100 is operated by the user (Step S256): if no (N), the device 100 keeps in a state ready to operate the second paired host BT2 (Step S255); if yes (Y), it is determined whether the operation is a short press made onto the button switch 103 (Step S257): if yes (Y), the process enters into the third determination module 603 through the connector \textcircled{O}; if no (N), the device 100 tries to reconnect with the second paired host BT2 for, e.g., 10 seconds (Step S258), and it is determined whether the device 100 has successfully reconnected with the second paired host BT2 (Step S259): if no (N), the process enters into the third determination module 603 through the connector \textcircled{O}; if yes (Y), the device 100 keeps in a state ready to operate the second paired host BT2 (Step S255).

The second determination module 602 further includes the following steps: if it is determined to be yes (Y) in Step S210, the process goes through Steps 255 and the subsequent steps; and if it is determined to be yes (Y) in Step S211, it is determined whether the third or the first identification code has not been stored in the memory 106 (Step S260): if yes (Y), the process enters into the third determination module 603 through the connector \textcircled{O}; if no (N), it is determined both whether the value of BT2 minus the value of BT1 is less than 0 and whether the value of BT2 minus the value of BT3 is less than 0 (Step S261): if no (N), the process enters into the third determination module 603 through the connector \textcircled{O}; if yes (Y), the process executes Step S251 and the subsequent steps through the connector Ⓢ.

Please refer to FIG. 6C again. The third determination module 603 further includes the following steps: if it is determined to be yes (Y) in Step S212, the device 100 tries to pair with the third new host 200₃ for, e.g., 1 minute (Step S271), and it is determined whether the device 100 has successfully paired with the third new host 200₃ (Step S272): if no (N), the process enters into the fourth determination module 604 through the connector \textcircled{P}; if yes (Y), the value of the variable P is added by 1 (Step S273), and the third new host 200₃ serves as the third paired host BT3, and the code value of BT3 is set to be equal to the current value of P (Step S274), and the device 100 is in a state ready to operate the third paired host BT3 (Step S275). At this moment, the one of the fields of the memory 106 decided according to the aforementioned FIFO principle to store the third identification code ID3 of the host 200₃. Then, it is determined whether the device 100 is operated by a user (Step S276): if no (N), the device 100 keeps in the state ready to operate the third paired host BT3 (Step S275); if yes (Y), it is determined whether the operation is a short press made onto the button switch 103 (Step S277): if yes (Y), the process enters into the fourth determination module 604 through the connector \textcircled{P}; if no (N), the device 100 tries to reconnect with the third paired host BT3 for, e.g., 10 seconds (Step S278), and it is determined whether the device 100 has successfully reconnected with the third paired host BT3 (Step S279): if no (N), the process enters into the fourth determination module 604 through the connector \textcircled{P}; if yes (Y), the device 100 keeps in the state operable to the third paired host BT3 (Step S275).

The third determination module 603 further includes the following steps: if it is determined to be yes (Y) in Step S214, the process goes through Step S275 and the subsequent steps; and it is determined to be no (N) in Step S214; it is determined if the value of N is equal to 0 (Step S215): if yes (Y), it is determined whether memory 106 has not the first or the second identification code (Step S280): if yes (Y), the process enters into the fourth determination module 604 through the connector \textcircled{P}; if no (N), it is determined both whether the value of BT3 minus the value of BT1 is less than 0 and whether the value of BT3 minus the value of BT2 is less than 0 (Step S281): if no (N), the process enters into the fourth determination module 604 through the connector \textcircled{P}; if yes (Y), the process executes Step S271 and the subsequent steps through the connector \textcircled{P}.

Please refer to FIGS. 4A-4D, 5A-5C, and 6A-6D again. The present invention can be explained from another macro perspective view.

### Embodiment 1

A method for enabling a device (100) to connect with plural hosts (200₁, 200₂, 200₃, 200₄, . . . , 200ₙ, 200ₚₛ₁ and (200ₚₛ₂), the plural hosts comprising a first host (200₁) and one of a preset host (200ₚₛ₁) and a second host (200ₚₛ₂), the method comprising the following steps:
(1) on a condition that the plural hosts comprise the preset host (200ₚₛ₁ or 200ₚₛ₂) and the first host (200₁), the method comprising the following steps:
   enabling the device (100) to enter a preset mode, comprising the following steps:
      enabling the device (100) to wirelessly connect with the preset host (200ₚₛ₁ or 200ₚₛ₂), and determining if the preset host (200ₚₛ₁ or 200ₚₛ₂) has been successfully wirelessly connected:
         if yes, causing the preset host (200ₚₛ₁ or 200ₚₛ₂) to be operable by the device (100); and
         if no, enabling the device (100) to exit the preset mode and enter into a first mode comprising the following steps:
   determining if the first host (200₁) has never been paired with the device (100):
      if never, enabling the device (100) to pair with the first host (200₁), and determine if the first host (200₁) has been successfully paired:
      if the first host (200₁) has been successfully paired, causing the first host (200₁) to be operable by the device (100); and
         if ever, enabling the device (100) to reconnect with the first host (200₁), and determine if the first host (200₁) has been successfully reconnected: if the first host (200₁) has been successfully reconnected, causing the first host (200₁) to be operable by the device (100); and
(2) on a condition that the plural hosts comprise the first host (200₁) and the second host (200₂), the method comprising the following steps:
   enabling the device (100) to enter into the first mode comprising the following steps:
   determining if the first host (200₁) has never been paired with the device (100):
      if never, enabling the device (100) to pair with the first host (200₁), and determine if the first host (200₁) has been successfully paired:
         if the first host (200₁) has been successfully paired, causing the first host (200₁) to be operable by the device (100); and
         if the first host (200₁) has not been successfully paired, enabling the first host (200₁) to exit the first mode and enter into a second mode; and
      if ever, enabling the device (100) to reconnect with the first host (200₁), and determine if the first host (200₁) has been successfully reconnected:
         if the first host (200₁) has been successfully reconnected, causing the first host (200₁) to be operable by the device (100); and
         if the first host (200₁) has not been successfully reconnected, enabling the first host (200₁) to exit the first mode and enter into the second mode comprising the following steps:
   determining if the second host (200₂) has never been paired with the device (100):
      if never, enabling the device (100) to pair with the second host (200₂), and determine if the second host (200₂) has been successfully paired:
         if the second host (200₂) has been successfully paired, causing the second host (200₂) to be operable by the device (100); and
      if ever, enabling the device (100) to reconnect with the second host (200₂), and determining if the second host (200₂) has been successfully reconnected:
         if the second host (200₂) has been successfully reconnected, causing the second host (200₂) to be operable by the device (100).

### Embodiment 2

The method according to Embodiment 1, wherein the first host (200₁) has a first identification code (ID1), the second host (200₂) has a second identification code (ID2), the device (100) has a memory (106) comprising a first field to store the first identification code (ID1) of the first paired host and the second identification code (ID21) of the second paired host.

### Embodiment 3

The method according to Embodiment 2, wherein the memory (106) further comprises a second field, and the first field and the second field store the first identification code (ID₁) and the second identification code (ID₂) respectively.

### Embodiment 4

The method according to Embodiment 3, wherein the plural hosts further comprise a third host (200₃) having a third identification code (ID₃), and when the third host (200₃) has been successfully paired, the method further comprises the following steps:
when the first field and the second field are both blank, storing the third identification code (ID₃) in one of the first field and the second field;
when neither the first field nor the second field is blank, storing the third identification code (ID₃) in one of the first field and the second field being firstly filled;
when only the first field is blank, storing the third identification code (ID₃) in the first field; and
when only the second field is blank, storing the third identification code (ID₃) in the second field.

### Embodiment 5

A method for enabling a device (100) to connect with plural hosts, wherein the plural hosts comprise a first host (200₁) and a second host (200₂), the method comprising the following steps:
determining if the first host (200₁) is operable by the device (100):
   if yes, causing the first host (200₁) to be operable by the device (100); and
if no, determining if the second host (200₂) has never been paired:
   if the second host (200₂) has never been paired, enabling the device (100) to pair with the second host (200₂) and causing the second host (200₂) to be operable by the device (100).

### Embodiment 6

The method according to Embodiment 5, wherein the device (100) has a remote adapter (101) for physically connecting with the first host (200₁) to cause the device (100) to wirelessly connect with the first host (200₁), wherein the step of causing the first host (200₁) to be operable by the device (100) comprises one of the following sub-steps (1) and (2):
(1) determining if the device (100) has wirelessly connected with the first host (200₁):
   if yes, setting the first host (200₁) as a preset host; and
   determining if the preset host has been operated by the device (100); and
(2) determining if the first host (200₁) has never paired:
   if never, enabling the device (100) to pair with the first host (200₁);
   determine if the first host (200₁) has been successfully paired; and
   determine if the first host (200₁) has been operated by the device (100).

### Embodiment 7

The method according to Embodiment 6, wherein the step of causing the second host (200₂) to be operable by the device (100) comprises one of the following steps:
determining if the second host (200₂) has never paired:
   if never, enabling the device (100) to pair with the second host (200₂);
   determine if the second host (200₂) has been successfully paired; and
   determine if the second host (200₂) is operatable by the device (100).

### Embodiment 8

The method according to Embodiment 6, wherein the device (100) further comprises a button switch (102ₐ or 102_{b}), wherein:
in the sub-steps (1), the step of determining if the first host (200₁) has been operated by the device (100) further comprises the following steps:
   determining if the device (100) has been operated by short-pressing the button switch (102ₐ or 102_{b}):
      if yes, determining if the second host (200₂) has never been paired; and
      if no, enabling the device (100) to wirelessly connect with the preset host (200ₚₛ₁); and
in the sub-steps (2), the step of determining if the first host (200₁) has been operated by the device (100) further comprises the following steps:
   determining if the device (100) has been operated by short-pressing the button switch (102ₐ or 102_{b}):
      if yes, determining if the second host (200₂) has never been paired; and
      if no, enabling the device (100) to reconnect with the first host.

### Embodiment 9

The method according to Embodiment 5, wherein the device (100) further comprises a plurality of indicator lights (103a, 103b and/or 103c) for indicating which of the first host (200₁) and the second host (200₂) is to operate.

### Embodiment 10

The method according to Embodiment 5, wherein the first host (200₁) has a first identification code (ID₁), the second host (200₂) has a second identification code (ID₂), and the device (100) has a memory (106) for storing the first identification code (ID₁) or the second identification code (ID₂).

### Embodiment 11

The method according to Embodiment 10, wherein the memory (106) is a random access memory, a flash memory or a combination thereof.

### Embodiment 12

The method according to Embodiment 5, wherein the device (100) is a bluetooth device being one of a bluetooth mouse and a bluetooth keyboard.

### Embodiment 13

A microprocessor (105) for enabling a device (100) to connect with plural hosts, the plural hosts comprising a first host (200₁) and a second host (200₂), and the microprocessor (105) comprising:
a first determination module configured to enable the device (100) to determine if the first host (200₁) is to be operable by the device (100); and
a second determination module configured to, when the device (100) has not been successfully connected with the first host (200₁), determine if the device (100) has ever been paired with the second host (200₂):
   if yes, enabling the device (100) to pair with the second host (200₂), and causing the second host (200₂) to be operable by the device (100); and
   if no, enabling the device (100) to reconnect with the second host (200₂), and causing the second host (200₂) to be operable by the device (100).

### Embodiment 14

The microprocessor (105) according to Embodiment 13, wherein the first determination module and the second determination module are two software modules in the microprocessor (105).

### Embodiment 15

The microprocessor (105) according to Embodiment 13, wherein the step of determining if the first host (200₁) is to be operable by the device (100) comprises the following steps:
determine if the device (100) has never been paired with the first host (200₁):
   if never, determine if the device (100) has been successfully paired with the first host (200₁):
      if the first host (200₁) has not been successfully paired, enabling the second determination module to be activated; and
      if the first host has been successfully paired, enabling the device (100) to be reconnected with the first host (200₁), and determining if the first host (200₁) has been successfully reconnected:
         if the first host (200₁) has been successfully reconnected, causing the first host (200₁) to be operable by the device (100); and
         if the first host (200₁) has not been successfully reconnected, enabling the second determination module to be activated.

### Embodiment 16

The microprocessor (105) according to Embodiment 15, wherein the first determination module is further configured to execute one of the following steps (1) and (2):
(1) on a condition that the device (100) further comprises a remote adapter (101) physically connected with a preset host (200ₚₛ₁) and the device (100) is wirelessly connectible with the preset host (200ₚₛ₁), before the step of the enabling the device (100) to determine if the first host (200₁) is to be operable by the device (100), the first determination module further comprising sub-steps of enabling the device (100) to enter into a preset mode, wherein the sub-steps comprise the following steps:
   enabling the device (100) to wirelessly connect with the preset host (200ₚₛ₁), and determining if the preset host (200ₚₛ₁) has been successfully wireless connected with the device (100):
      if yes, enabling the preset host (200ₚₛ₁) to be operable by the device (100); and
      if no, enabling the device (100) to exit the preset mode and enter into a first mode comprising a step of determining if the first host (200₁) has never been paired with the device (100):
      if never, enabling the device (100) to pair with the first host (200₁), and determining if the first host (200₁) has been successfully paired with the device (100):
         if the first host (200₁) has been successfully paired, causing the first host (200₁) to be operable by the device (100); and
      if ever, enabling the device (100) to reconnect with the first host (200₁) and determining if the first host (200₁) has successfully reconnected with the device (100):
         if the first host (200₁) has been successfully reconnected, causing the first host (200₁) to be operable by the device (100); and
(2) on a condition that the remote adapter (101) is physically connected with the preset host (200ₚₛ₁) and the device (100) fails to wirelessly connect with the preset host (200ₚₛ₁), enabling the device (100) to enter into a second mode, wherein:
   the step of determining if the device (100) has been successfully paired with the first host (200₁) further comprises the following steps:
      if the first host (200₁) has not been successfully paired, enabling the device (100) to exit the first mode and enter into the second mode; and the step of determining if the first host (200₁) has been successfully reconnected with the device (100) further comprises the following steps:
      if the first host (200₁) has not been successfully reconnected, enabling the device (100) to exit the first mode and enter into the second mode, wherein:
   the step of determining if the second host (200₂) has never been paired comprises the following steps:
      if the second host (200₂) has never been paired with the device (100), after the step of enabling the device (100) to pair with the second host (200₂), determining if the second host (200₂) has been successfully paired:
         if the second host (200₂) has been successfully paired, causing the second host (200₂) to be operable by the device (100); and
      if the second host (200₂) has ever been paired, enabling the device (100) to reconnect with the second host (200₂), and determining if the second host (200₂) has been successfully reconnected:
         if the second host (200₂) has been successfully reconnected, causing the second host (200₂) to be operable by the device (100).

### Embodiment 17

The microprocessor (105) according to Embodiment 16, wherein the plurality of hosts further comprise a third host (200₃) having a third identification code (ID₃), the first host (200₁) has a first identification code (ID₁), the second host (200₂) has a second identification code (ID₂), the microprocessor (105) further comprises a memory (106) having a first field and a second field each for storing the first identification code (ID₁), the second identification code (ID₂) or a third identification code (ID₃).

### Embodiment 18

The microprocessor (105) according to Embodiment 16, wherein the step of determining if the second host (200₂) has been successfully paired with the device (100) further comprises the following steps:
if the second host (200₂) has not been successfully paired with the device (100), enabling the device (100) to exit the second mode and enter into a third mode comprising the following step:
   determining if the third host (200₃) has never been paired with the device (100):
      if never, enabling the device (100) to pair with the third host (200₃), and determining if the third host (200₃) has been successfully paired:
         if the third host (200₃) has been successfully paired, causing the third host (200₃) to be operable by the device (100), and
         when the first field and the second field are both blank, enabling the first field to store the third identification code (ID₃);
         when neither the first field nor the second field is blank, in a first-in-first out (FIFO) manner, enabling one of the first field and the second field having been firstly filled to store the third identification code (ID₃); and
         when one of the first field and the second field is blank and the other one is not blank, enabling the other one to store the third identification code (ID₃).

### Embodiment 19

The microprocessor (105) according to Embodiment 17, wherein the memory (106) is one of a random access memory and a flash memory, or a combination thereof.

### Embodiment 20

The microprocessor according to Embodiment 13, wherein the device (100) is a bluetooth device being one of a bluetooth mouse and a bluetooth keyboard.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for enabling a device to connect with plural hosts, the plural hosts comprising a first host and one of a preset host and a second host, the method comprising the following steps:
(1) on a condition that the plural hosts comprise the preset host and the first host, the method comprising the following steps:
enabling the device to enter a preset mode, comprising the following steps:
enabling the device to wirelessly connect with the preset host, and determining if the preset host has been successfully wirelessly connected:
if yes, causing the preset host to be operable by the device; and
if no, enabling the device to exit the preset mode and enter into a first mode comprising the following steps:
determining if the first host has never been paired with the device:
if never, enabling the device to pair with the first host, and determine if the first host has been successfully paired:
if the first host has been successfully paired, causing the first host to be operable by the device; and
if ever, enabling the device to reconnect with the first host, and determine if the first host has been successfully reconnected:
if the first host has been successfully reconnected, causing the first host to be operable by the device; and
(2) on a condition that the plural hosts comprise the first host and the second host, the method comprising the following steps:
enabling the device to enter into the first mode comprising the following steps:
determining if the first host has never been paired with the device:
if never, enabling the device to pair with the first host, and determine if the first host has been successfully paired:
if the first host has been successfully paired, causing the first host to be operable by the device; and
if the first host has not been successfully paired, enabling the first host to exit the first mode and enter into a second mode; and
if ever, enabling the device to reconnect with the first host, and determine if the first host has been successfully reconnected:
if the first host has been successfully reconnected, causing the first host to be operable by the device; and
if the first host has not been successfully reconnected, enabling the first host to exit the first mode and enter into the second mode comprising the following steps:
determining if the second host has never been paired with the device:
if never, enabling the device to pair with the second host, and determine if the second host has been successfully paired:
if the second host has been successfully paired, causing the second host to be operable by the device; and
if ever, enabling the device to reconnect with the second host, and determining if the second host has been successfully reconnected:
if the second host has been successfully reconnected, causing the second host to be operable by the device.

2. The method according to claim 1, wherein the first host has a first identification code, the second host has a second identification code, the device has a memory comprising a first field to store the first identification code of the first paired host and the second identification code of the second paired host.

3. The method according to claim 2, wherein the memory further comprises a second field, and the first field and the second field store the first identification code and the second identification code respectively.

4. The method according to claim 3, wherein the plural hosts further comprise a third host having a third identification code, and when the third host has been successfully paired, the method further comprises the following steps:
when the first field and the second field are both blank, storing the third identification code in one of the first field and the second field;
when neither the first field nor the second field is blank, storing the third identification code in one of the first field and the second field being firstly filled;
when only the first field is blank, storing the third identification code in the first field; and
when only the second field is blank, storing the third identification code in the second field.

5. A method for enabling a device to connect with plural hosts, wherein the plural hosts comprise a first host and a second host, the method comprising the following steps:
determining if the first host is operable by the device:
if yes, causing the first host to be operable by the device; and
if no, determining if the second host has never been paired:
if the second host has never been paired, enabling the device to pair with the second host and causing the second host to be operable by the device.

6. The method according to claim 5, wherein the device has a remote adapter for physically connecting with the first host to cause the device to wirelessly connect with the first host, wherein the step of causing the first host to be operable by the device comprises one of the following sub-steps (1) and (2):
(1) determining if the device has wirelessly connected with the first host:
if yes, setting the first host as a preset host; and
determining if the preset host has been operated by the device; and
(2) determining if the first host has never paired:
if never, enabling the device to pair with the first host;
determine if the first host has been successfully paired; and
determine if the first host has been operated by the device.

7. The method according to claim 6, wherein the step of causing the second host to be operable by the device comprises one of the following steps:
determining if the second host has never paired:
if never, enabling the device to pair with the second host;
determine if the second host has been successfully paired; and
determine if the second host is operatable by the device.

8. The method according to claim 6, wherein the device further comprises a button switch, wherein:
in the sub-steps (1), the step of determining if the first host has been operated by the device further comprises the following steps:
determining if the device has been operated by short-pressing the button switch:
if yes, determining if the second host has never been paired; and
if no, enabling the device to wirelessly connect with the preset host; and
in the sub-steps (2), the step of determining if the first host has been operated by the device further comprises the following steps:
determining if the device has been operated by short-pressing the button switch:
if yes, determining if the second host has never been paired; and
if no, enabling the device to reconnect with the first host.

9. The method according to claim 5, wherein the device further comprises a plurality of indicator lights for indicating which of the first host and the second host is to operate.

10. The method according to claim 5, wherein the first host has a first identification code, the second host has a second identification code, and the device has a memory for storing the first identification code or the second identification code.

11. The method according to claim 10, wherein the memory is a random access memory, a flash memory or a combination thereof.

12. The method according to claim 5, wherein the device is a bluetooth device being one of a bluetooth mouse and a bluetooth keyboard.

13. A microprocessor for enabling a device to connect with plural hosts, the plural hosts comprising a first host and a second host, and the microprocessor comprising:
a first determination module configured to enable the device to determine if the first host is to be operable by the device; and
a second determination module configured to, when the device has not been successfully connected with the first host, determine if the device has ever been paired with the second host:
if yes, enabling the device to pair with the second host, and causing the second host to be operable by the device; and
if no, enabling the device to reconnect with the second host, and causing the second host to be operable by the device.

14. The microprocessor according to claim 13, wherein the first determination module and the second determination module are two software modules in the microprocessor.

15. The microprocessor according to claim 13, wherein the step of determining if the first host is to be operable by the device comprises the following steps:
determine if the device has never been paired with the first host:
if never, determine if the device has been successfully paired with the first host:
if the first host has not been successfully paired, enabling the second determination module to be activated; and
if the first host has been successfully paired, enabling the device to be reconnected with the first host, and determining if the first host has been successfully reconnected:
if the first host has been successfully reconnected, causing the first host to be operable by the device; and
if the first host has not been successfully reconnected, enabling the second determination module to be activated.

16. The microprocessor according to claim 15, wherein the first determination module is further configured to execute one of the following steps (1) and (2):
(1) on a condition that the device further comprises a remote adapter physically connected with a preset host and the device is wirelessly connectible with the preset host, before the step of the enabling the device to determine if the first host is to be operable by the device, the first determination module further comprising sub-steps of enabling the device to enter into a preset mode, wherein the sub-steps comprise the following steps:
enabling the device to wirelessly connect with the preset host, and determining if the preset host has been successfully wireless connected with the device:
if yes, enabling the preset host to be operable by the device; and
if no, enabling the device to exit the preset mode and enter into a first mode comprising a step of determining if the first host has never been paired with the device:
if never, enabling the device to pair with the first host, and determining if the first host has been successfully paired with the device:
if the first host has been successfully paired, causing the first host to be operable by the device; and
if ever, enabling the device to reconnect with the first host and determining if the first host has successfully reconnected with the device:
if the first host has been successfully reconnected, causing the first host to be operable by the device; and
(2) on a condition that the remote adapter is physically connected with the preset host and the device fails to wirelessly connect with the preset host, enabling the device to enter into a second mode, wherein:
the step of determining if the device has been successfully paired with the first host further comprises the following steps:
if the first host has not been successfully paired, enabling the device to exit the first mode and enter into the second mode; and
the step of determining if the first host has been successfully reconnected with the device further comprises the following steps:
if the first host has not been successfully reconnected, enabling the device to exit the first mode and enter into the second mode, wherein:
the step of determining if the second host has never been paired comprises the following steps:
if the second host has never been paired with the device, after the step of enabling the device to pair with the second host, determining if the second host has been successfully paired:
if the second host has been successfully paired, causing the second host to be operable by the device; and
if the second host has ever been paired, enabling the device to reconnect with the second host, and determining if the second host has been successfully reconnected:
if the second host has been successfully reconnected, causing the second host to be operable by the device.

17. The microprocessor according to claim 16, wherein the plurality of hosts further comprise a third host having a third identification code, the first host has a first identification code, the second host has a second identification code, the microprocessor further comprises a memory having a first field and a second field each for storing the first identification code, the second identification code or a third identification code.

18. The microprocessor according to claim 16, wherein the step of determining if the second host has been successfully paired with the device further comprises the following steps:
if the second host has not been successfully paired with the device, enabling the device to exit the second mode and enter into a third mode comprising the following step:
determining if the third host has never been paired with the device:
if never, enabling the device to pair with the third host, and determining if the third host has been successfully paired:
if the third host has been successfully paired, causing the third host to be operable by the device, and
when the first field and the second field are both blank, enabling the first field to store the third identification code;
when neither the first field nor the second field is blank, in a first-in-first out (FIFO) manner, enabling one of the first field and the second field having been firstly filled to store the third identification code; and
when one of the first field and the second field is blank and the other one is not blank, enabling the other one to store the third identification code.

19. The microprocessor according to claim 17, wherein the memory is one of a random access memory and a flash memory, or a combination thereof.

20. The microprocessor according to claim 13, wherein the device is a bluetooth device being one of a bluetooth mouse and a bluetooth keyboard.
